(19) United States
(12) Patent Application Publication
(10) Pub. No.: US 2004/0074719 A1
(43) Pub. Date: Apr. 22, 2004

(54) Pile weatherstripping and methods of making same

(76) Inventor: David M Loughney, Phelps, NY (US)

Correspondence Address: Kenneth J LuKacher, South Winton Court, Suite 204, 3136 Winton Road South, Rochester, NY, 14623, US

(21) Appl. No.: 10/332,091

(22) PCT Filed: May 24, 2002
(86) PCT No.: PCT/US02/16612

(51) Int. Cl. B32B 3/02

(52) U.S. Cl. 188/267.1; 428/85

(57) ABSTRACT

Pile weatherstripping has a pile of yarn segments (20) which are attached to a flexible plastic backing strip (1) by ultrasonic welding (21) of the pile thereto. Loops of the yarn (20) are captured in a channel (16) on one side of the backing strip. This channel is formed by extracting flanges (15) from the backing strip by a cutting tool (FIG. 8) having a pair of chiseled cutting surfaces (2a, 2b) tapering inwardly and spaced from each other. The backing strip is preferably wound on a capstan (9) in a plurality of turns so as to feed the strip past the cutting tool. The cutting tool leaves notches along the channel on the outside of the flanges. The base of the channel is unaffected by the cutting tool and presents a stress-free surface at which the yarn is welded. The notches improve thc bending strip flexibility of the backing so as to facilitate insertion of the weatherstrip into a T-slot (22).

### DESCRIPTION

The present invention relates to improved pile weatherstripping. More generally, the invention relates to articles which are made by ultrasonic welding yarn to plastic strips or strands. Such welded articles include weatherstripping, brushes, and other articles having tuffs of yarn or pile attached to a backing strip or strand. The invention includes methods and apparatus for making these articles.

The invention improves weatherstripping and methods of making weatherstripping described in U.S. Pat. No. 4,302,494, issued Nov. 24, 1981 to Robert C. Horton. Improvements to weatherstripping and weatherstripping fabricating methods are described in Johnson et al., U.S. Pat. No. 5,338,382, issued Aug. 16, 1994 and Johnson, U.S. Pat. No. 5,807,451, issued Sep. 15, 1998 and U.S. Pat. No. 5,817,390, issued Oct. 6, 1998. Pile weatherstripping which is manufactured in accordance with the Horton and Johnson Patents uses a plastic backing strip, one side of which is formed into a channel by plowing and upsetting the material fit that side into a pair of flanges by a plowing tool. The channel has a base against which loops of strands of yarn are captured and ultrasonically welded to create the weatherstrip. The quality of the weatherstrip depends upon the strength and uniformity of the weld section which connects the yam to the backing strip.

It is the principal object of this invention to provide improved articles, especially weatherstripping, having yarn segments ultrasonically welded to a backing strip in the base of a channel formed of material upset from the backing strip, where the weld is consistently of high quality and where the welding may be carried on at higher line speeds (the speed at which the weatherstrip travels past the welding head during the manufacture of the pile weatherstrip); this line speed being higher than in the case of the weatherstrip manufactured heretofore, and particularly manufactured in accordance with the Horton and Johnson Patents.

More particularly, the invention enables fabrication of the flanges which guide and capture the yarn, in the course of manufacture of the weatherstripping, so that no significant stress fracturing occurs in the backing (the base of the channel between the flanges) where it is welded to the pile. The absence of stress in the base of the channel enables the flanges to direct the ultrasonic energy for welding, and uses the welding energy more effectively and efficiently.

In accordance with the invention, the flange guides are upset from the outside of the channel rather than from the inside as is the case in the Horton and Johnson Patents. The walls of the flanges are vertical and located, preferably centrally, between the edges of the backing. The area at the base of the channel (the width of the channel) maybe of substantially constant and uniform in size and compatible with the bottoms of the loops of the yarn so as to form flanges which serve as an ultrasonic energy beam director for efficient and effective utilization of the ultrasonic energy to weld the backing to the pile.

Another object of the invention is to facilitate installation of the pile weatherstripping in a T-slot in window and door frames so that the pile is easily inserted either by rolling the backing into the throat of the T-slot or by insertion in the end of the T-slot.

Rolling the backing into the T-slot has required special facilities for bending the backing strip. It has even been proposed to score or slit the backing strip. See U.S. Pat. No. 4,528,736, issued Jul. 16, 1985 to Hope et al.

When installed either by rolling or insertion, (for an insertion machine see Miller et al., U.S. Pat. No. 5,758,400, issued Jun. 2, 1998) the weatherstrip and T-slot are sometimes staked, such as described, for example, in U.S. Pat. No. 5,979,036, issued Nov. 9, 1999, or the frictional engagement of the backing strip against the walls of the T-slot is enhanced as by means of series of nubbins to restrict movement of the weatherstripping within the T-slot, such as described, for example, in Johnson, U.S. Pat. No. 5,438,802, issued Aug. 8, 1995.

It is an object of the invention to provide an improved weatherstrip and method of making same which facilitates the insertion of the weatherstrip into the T-slot without jamming. The invention also enables the backing to be formed into arcuate, particularly convex or concave, shapes, and even undulating or wave shaped longitudinally along the weatherstrip, so as to form an interference fit when inserted in the T-slot which restricts the movement of the weatherstrip and enhance the seal. The ease of insertion and formation into arcuate or undulating shape is facilitated by the reduced section or notch outside the channel and adjacent to the outsides of the flanges. The notch increases the flexibility of the backing strip along its width. The backing flexes for insertion into the T-slot, The reduced section in the notch also facilitates cold forming of the backing strip into convex or concave or even undulating shapes so as to enhance the interference fit between The weathertstripping and the interior walls of the T-slot, thereby creating a tight fit restricting the movement of the weatherstripping in the T-slot with respect to the frame of the door or window and promoting a tight air infiltration seal in the frame of the door or window.

Further in accordance with the invention, the base of the channel may be provided with a textured surface, preferably with a knurling rube disposed downstream with respect to the movement of the weatherstrip during formation of the flanges. The separation between the knurling and cutting tools is desirably sufficient to prevent imparting any stain in the material of the weatherstripping in the channel.

In summary, pile weatherstripping of the present invention has a pile of yarn segments which are attached to a flexible plastic backing strip by ultrasonic welding of the pile thereto. Loops of the yarn are captured in a channel on one side of the backing strip. This channel is formed by extracting flanges from the backing strip by a cutting tool having a pair of chiseled cutting surfaces tapering inwardly and spaced from each other. The backing strip is preferably wound on a capstan in a plurality of turns so as to feed the strip past the cutting tool which extends radially toward the periphery of the capstan and into cutting engagement with the backing strip. The cutting tool leaves notches along the channel on the outside of the flanges. The base of the channel is unaffected by the cutting tool and thus presents a stress-free surface at which the yarn is welded. The weld section, connecting the loops of yamn to the backing strip, is consistent throughout the length and cross-section of the weatherstrip even when the welding is carried out at high speeds. The notches improve the bending flexibility of the backing strip so as to facilitate insertion of the weatherstrip into a T-slot of a window or door frame which is to be sealed using the weatherstrip. The backing strip may be permanently set to form a convex or concave cross-section, the edges of which engage an interior wall of the T-slot to Fictionally capture the backing and the weatherstripping in the T-slot with the pile projecting therefrom.

The foregoing and other objects, features, and advantages will become more apparent from a reading of the following description in connection with the accompanying drawings in which;

FIG. 1 is a plan view, schematically illustrating apparatus for forming a backing strip in the manufacture of pile weatherstripping;

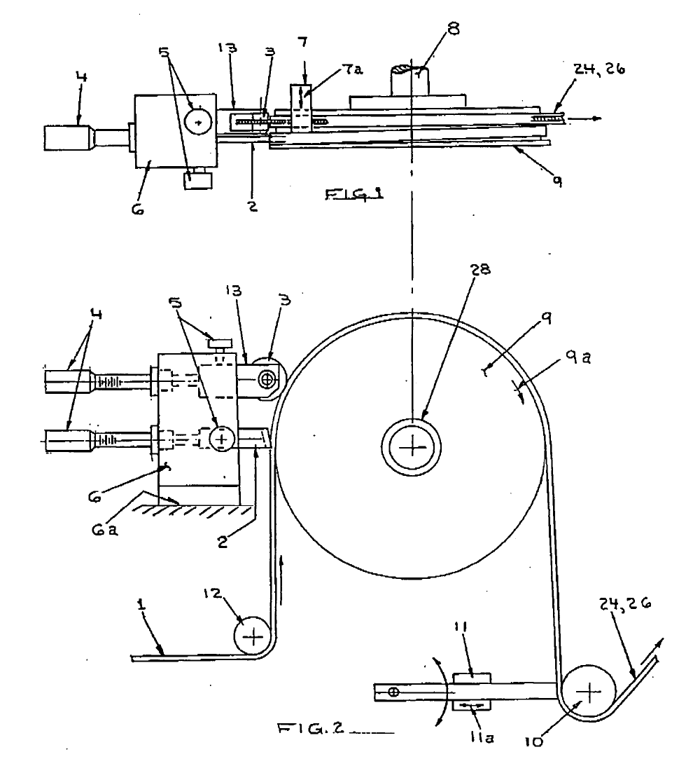

FIG. 2 is a front view of the apparatus shown in FIG. 1;

FIG. 3 is a cross-sectional view of the backing strip as it enters the apparatus shown in FIGS. 1 and 2;

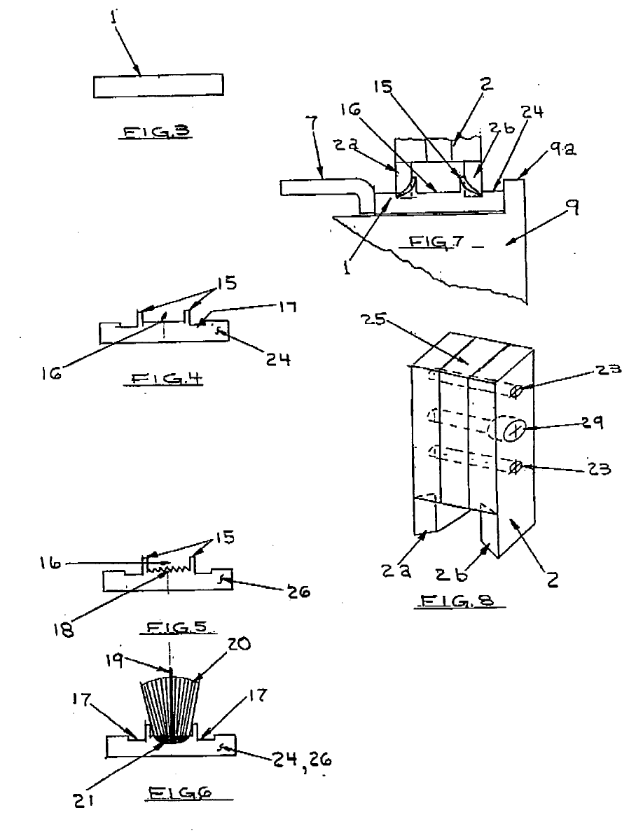

FIG. 4 is a cross-sectional view of the backing strip after the flanges ame upset and cold formed by the cutting tool in the apparatus shown in FIGS. 1 and 2;

FIG. 5 is a cross-sectional view of the backing strip after formation of a knurled textured surface at the base of the channel between the flanges by means of a knurling tool in the apparatus shown in FIGS. 1 and 2;

FIG. 6 is a cross-sectional view of the finished pile weatherstripping after welding of the loop d strands of yarn in the base of the channel and showing th ultrasonically formed weld section;

FIG. 7 is a fragmentary end view illustrating the cutting tool in process of upsetting the backing strip from a side thereof, thereby cold forming the backing strip into flanges defining a channel, the inside walls of the flanges being straight and upright;

FIG. 8 is a perspective view of the cutting tool which forms the flanges and the channel in the backing strip;

FIG. 9 is a sectional view of weatherstrip disposed in a T-slot in frame of a window or door which is sealed by the weatherstrip, the backing strip being cold formed into a concave shape to provide an interference fit of the weatherstrip in the T-slot;

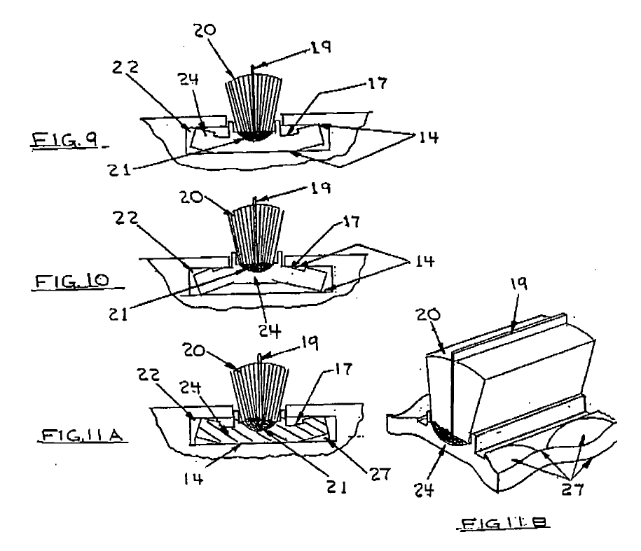

FIG. 10 is a view similar to FIG. 9 with the backing strip cold formed into convex shape;

FIGS. 11A and 11B are respectively a sectional view of a weatherstrip having an undulating or wavy shape backing strip disposed in the T-slot, and a fragmentary perspective view thereof.

Referring to the drawings thereshown in FIGS. 1 and 2 a backing strip 1 of thermoplastic material, preferably polypropylene. This backing strip has a generally rectangular configuration as shown in FIG. 3 and may typically be of the order of 1/4 inch long and 1/32 inch high. The cross-sectional size of the backing strip depends upon the size of the pile to be fabricated with the weatherstrip The backing strip is unwound from a roll (not shown) and guided around a guide wheel or pulley 12 to a capstan wheel 9. This wheel 9 has a flange 9a against which the backing strip 1 is referenced and held by a backing strip support guide 7 which is moveable in the direction indicated by the arrows 7a. The backing strip makes a plurality of turns, two turns being illustrated, around the periphery of the capstan wheel 9. The backing strip leaves the wheel after the second urn and after the formation of the flanges 15 and channel 16 therein. The base of the channel 16 may be left pristine and smooth with flanges 15 extracted from the top side of the backing strip and notches 17 adjacent to the flanges and between the flanges and the outer edges of the strip (see FIG. 4 at 24). Alternatively and optionally, the base of the channel 16 may be textured as shown at 18 in FIG. 5 The backing strip with the textured channel base is illustrated at 26 in FIG. 5. Since the backing strip may have the alternative shapes as shown in FIGS. 4 and 5, both reference numerals 24 and 26 are used to designate the backing strip leaving the capstan wheel 9.

A dancer mechanism 10 with a pulley around which the backing strip is guided is disposed at the exit end of the capstan wheel 9. The amount of tension in the departing backing strip is controlled by means of a weight which is movable in the direction indicated by the arrows 11a on the arm of the dancer mechanism.

The capstan wheel 9 is driven from a shaft 8 through a one-way clutch 28 which enables the capstan wheel to be freely rotated in a clockwise direction indicated by the arrow 9a. The motor and drive for the shaft 8 is not shown to simplify the illustration.

A cutting tool 2 and a knurling tool 3 are supported in a block 6 mounted on the frame of the backing strip forming apparatus, illustrated schematically at 6a. The cutting tool 2 is movable along a radius of the capstan wheel 9 into engagement with the backing strip 1 as it enters the first turn of the backing around the capstan wheel. The knurling tool 3 has a knurling wheel mounted on a rod movable in the support block 6 in the position off set laterally from the cutting tool 2 so that it engages the backing strip in the second turn thereof around the capstan wheel 9. This spaces the cutting and knurling tools and isolates them so that the backing strip is not placed under strain, as would be the case if the knurling and cutting tool were in close proximity to each other. Ultrasonic welding is enhanced by virtue of the lack of strain in the base of the channel 16 of the backing strip, where the weld section is formed.

In the Horton patent, a channel is formed in the backing by means of a plow which is disposed centrally of the width of the backing strip. The flanges are the furrow which is made by the plow. The inside wall of the flanges and the base of the channel are stressed by the plowing process and may contain stress fractures.

After leaving the dancer mechanism 10, the formed backing strip is guided to the machine which fabricates the yarn loops and feeds the backing strip so that the loops of yarn enter the channel 16 and are then ultrasonically welded, such as shown in the above referenced Horton and Johnson patents.

The cutting tool 2 and knurling tool 3 are movable into the side of the backing strip 1 which is exposed on the capstan wheel 9 by means of screw micrometer adjustment mechanisms 4. When advanced to the desired penetration depth by the micrometer mechanisms 4, the tools 2 and 3 are locked in place by tool position lock screws 5.

The cutting tool 2 has spaced chisel cutting edges 2a and 2b. These edges upset and cold form the flanges 15. They leave the base pristine and strain free while removing material between the flanges and the edges of the backing strip which creates indentation or notches. The channel 16 is precisely defined with a strain free base. Its has been found that the ultrasonic welding of the yarn loops in the channel to the base of the channel produces a higher quality weld section which is consistent even though the line speed at which the backing strip and yarn moves past the ultrasonic welding head may be increased over and above the speed used with a centrally plowed channel as described in the above-referenced Horton and Johnson patents. The weld section 21 (see FIG. 6) firmly, securely, and consistently attaches the yarn loops of thermoplastic (propylene yarn) and which has a barrier film 19, if desired.

The notches 17 have the additional advantage of reducing the thickness of the backing strip 1 and enabling it to be flexible and bending about the width of the backing strip. This bending or hinging action makes the insertion of the backing strip in a T-slot of a window or frame, such as shown at 22 in FIGS. 9, 10, and 11A, easier to be accomplished especially by mechanisms for rolling the weatherstrip into the T-slot.

In order to facilitate making the channel 16 of differing widths to accommodate pile of various sizes, the spacing of the chisel cutting edges 2a and 2b may be adjustable by inserting spacer blocks 25 of different width. The alignment of the chisel parts 2a and 2b is maintained by alignment pins 23 and the parts are held in place by a support screw 29 (see FIG. 8).

The welding of the yam loops in the channel 16 may be facilitated by texturing the base. Such texturing is accomplished by means of the knurling tool 3. The knurled surface 18 (see FIG. 5) may present a greater area than the pristine surface as shown in FIG. 4, and may be easier to melt with less ultrasonic energy. Accordingly, although the use of a knurled channel base is optional, it is presently preferred.

The thickness reduction in the notches 17 enables the backing strip 1 to be bent and deflected so as to be permanently set and form the arcuate (concave or convex) shapes as shown in FIGS. 9 and 10. These shapes result in points of contact as indicated at 14 in FIGS. 9 and 10 with the interior walls of the T-slot. The longitudinal movement of the weatherstrip in the T-slot is thereby reduced in the manner similar to the nubbins shown in Johnson, U.S. Pat. No. 5,438,802, referenced above. Cold forming to provide the convex or concave shapes may be accomplished with rolling tools having the desired shape. Such cold forming is preferably performed after the weatherstrip is fabricated in the machine such as shown in above-referenced Horton and Johnson patents but before installation in the T-slot. The backing strip 1 may also be cold formed into shapes shown in FIGS. 11A and 11B having longitudinal waves with indentations and ridges. The ridges on successive undulations or waves are on opposite sides of the backing. This enhances the seal in the T-slot as well as the frictional, interference fit of the weatherstrip in the T-slot. Weatherstrips having shaped backing strips as shown in FIGS. 9, 10 and 11 are preferably inserted into the T-slot from one end thereof, rather than rolled through the throat of the slot.

In operation, the cutting tool 2 and the knurling tool 3 are backed away from the capstan wheel 9 to enable the backing strip 1 to be threaded into the apparatus around the guide wheels 10 and 12 and to wrap the pair of turns on the periphery of the capstan wheel 9.

Then the cutting tool 2 and the knurling tool 3 are advanced by the micrometer adjustment mechanisms 4 until contact with the backing strip is made so as to calibrate the micrometer mechanisms 4 at the position where the tools 2 and 3 just touch the surface of the exposed side of the backing strip 1 on the capstan wheel 9.

Then the micrometer mechanisms are advanced so that the tools 2 and 3 are inserted to the requisite penetration depth into the backing strip 1. Tha lock screws 5 are then tightened and the support guides 7 is adjusted to prevent the backing strip from wandering laterally on the capstan wheel 9.

The one-way clutch 28 enables the capstan wheel 9 to be manually rotated clockwise. This pulls the backing strip 1 through the tools 2 and 3 so as to form the backing strip into the desired profile with the flanges and notches.

The backing strip 1 is then measured to ensure that the profile is correct The motor that rotates the shaft 8 and the capstan wheel 9 is then engaged to continuously form the backing strip. The backing strip is then fed to the weatherstrip fabricating machine, which may be a machine of the type described in the above-referenced Horton and Johnson patents, which are incorporated herein by reference.

Although the invention is described for weatherstripping, it may be used for making other articles, such as brushes. For example, the yarn pile once ultrasonically welded to the backing strip 1 may provide a unitary brush or a member for a brush The yam providing the brush bristles may be made of substantially stiff material, the degree and composition of such depending on the brush application.

Variations and modifications in the herein described weatherstrips and apparatus, and methods for making same, within the scope of the invention will undoubtedly suggest themselves to those skilled in the art. Accordingly, the foregoing description should be taken as illustrative and not in a limiting sense.

1. An article adapted to provide a weatherstrip comprising a strip f plastic material, a pile of yarn segments extending from a side of said strip, said strip being a backing for said pile, flanges of material extracted from said side forming a channel in which said pile is disposed, said extracted flanges leaving notches adjacent thereto in said side of said backing, between said channel and edges of said side.

2. The weatherstrip according to claim 1 wherein said flanges and notches are cold formed.

3. The weatherstrip according to claim 2 wherein said cold formed flanges and notches are plowed or chiseled from material of said strip on said side of said strip.

4. The weatherstrip according to claim 1 wherein a connection between said pile and backing in said channel is provided by an ultrasonic weld.

5. The weatherstrip according to claim 4 wherein said channel includes a base between said flanges thereof provided by the material of said backing strip, said base is knurled or textured and said connection is to said knurled or textured base.

6. The weatherstrip according to claim 1 wherein said notches are of sufficient depth to increase the flexibility for bending of said strip at said notches.

7. The weatherstrip according to claim 1 wherein said strip is arcuate in cross-section sufficiently for said edges to engage an interior wall of a slot in which said weatherstrip is disposed with said pile extending out of said slot.

8. The weatherstrip according to claim 7 wherein said arcuate cross-section is convex so that said edges engage a top of said slot which provides said interior wall.

9. The weatherstrip according to claim 7 wherein said arcuate cross-section is concave so that said edges engage a base of said slot which provides said interior wall.

10. The weatherstrip according to claim 7 wherein said arcuate cross-section is cold formed to provide a permanent set to said backing strip.

11. The weatherstrip according to claim 10 wherein said sides of said backing strip are wave shaped along their length to dine indentations and ridges along said sides of said backing strip so that said ridges on opposite sides engage opposed interior walls of said slot at longitudinally spaced locations.

12. The weatherstrip according to claim 11 wherein said strip is cold formed to define said shaped sides.

13. In a method of making pile weatherstrip having a backing strip of plastic from one side of which flanges extend to define a channel in which loops of yam providing said pile are attached to said backing strip and from which said pile extends away from said side, the improvement comprising extracting said flanges separately from said sides, each being extracted between an edge of said strip and locations inward from said edges of said side so that said flanges form said channel and without the forming said backing strip where said side thereof defines a base of said channel.

14. The method according to claim 13 wherein said extracting step is carried to define notches adjacent to said flanges and between said flanges and said edges, said notches being of sufficient depth to impart bending flexibility to said strip about axis extending longitudinally of said weatherstrip along said notches.

15. The method according to claim 13 wherein said extracting step is carried out with the aid of a plow or chisel cutting tool having a pair of teeth spaced from each other a distance corresponding to the separation of said flanges on opposite sides of said channel.

16. The method according to claim 15 further comprising adjusting the spacing said teeth of said tool to select the width of said channel.

17. The method according to claim 15 wherein said teeth have cutting edges flaring inwardly toward each other away from vertical walls which enters said side of said backing strip during said extracting step.

18. The method according to claim 15 further comprising texturing the base of said channel to increase the adherability of said pile therein.

19. The method according to claim 18 wherein said texturing step is carried out with the aid of a knurling tool.

20. The method according to claim 19 further comprising spacing said knurling tool away from said cutting tool along said backing strip a sufficient distance to avoid imparting the strain in the material of said backing strip.

21. The method according to claim 15 wherein said pile is attached to said base by an ultrasonic weld.

22. The method according to claim 18 wherein said pile is attached to said pile and said textured base to each other.

23. The method according to claim 15 further comprising the step of wrapping said backing strip a plurality of turns about a capstan, inserting said cutting tool into said pile on said capstan and rotating said capstan to drive said pile past that tool to extract said flanges from said side from said backing strip.

24. The method according to claim 23 flintier comprising extending said knurling tool into the base of said channel between said flanges after extraction thereof to textures said base.

25. The method according to claim 24 further comprising locating said knurling tool adjacent to one of said plurality of turns of said backing strip on said capstan spaced from said turn of said backing strip where said cutting tool engages said backing strip.

26. An apparatus for making pile weatherstrip comprising a backing strip of thermoplastic material, a cutting tool having cutting edges spaced from each other width wise of said weatherstrip and penetrating partially into a side of said backing strip, said strip being movable longitudinally with respect to said cutting tool to upset a pair of flanges from said side and form a channel into which said pile is disposed for thermal welding to a base of a channel defined between said flanges.

27. The apparatus according to claim 26 wherein said cutting edges are chisel shape having walls parallel to each other from which said edges flare outwardly and downwardly toward said backing strip whereby said flanges are cold formed from the outside toward the outside of said strip.

28. The apparatus according to claim 26 farther comprising another tool disposed to enter said channel and cold form a texturized surface on said base.

29. The apparatus according to claim 27 further comprising a rotatable capstan wheel around which a plurality of terms of said backing strip are wrapped, said cutting tool being opposed to the periphery of said wheel and being movable into penetrating relationship with said side of said strip on said wheel.

30. An article for making a weatherstrip or brush comprising:
a strip of material having at least one side with two edges;
a pile extending from said side of said strip;
two flanges of material extracted from said side forming a channel therebetween in which said pile is disposed; and
two notches being formed with said flanges in said side of said strip between the flanges and the edges of said strip.
